(19) United States
(12) Patent Application Publication
(10) Pub. No.: US 2025/0226429 A1
(43) Pub. Date: Jul. 10, 2025

(54) FUEL CELL SYSTEM AND METHOD OF CONTROLLING SAME

(71) Applicants: HYUNDAI MOTOR COMPANY, Seoul (KR); Kia Corporation, Seoul (KR)

(72) Inventor: Hun Woo Park, Namyangju-si (KR)

(73) Assignees: HYUNDAI MOTOR COMPANY, Seoul (KR); Kia Corporation, Seoul (KR)

(21) Appl. No.: 18/937,977

(22) Filed: Nov. 5, 2024

(30) Foreign Application Priority Data
Jan. 8, 2024 (KR) 10-2024-0002646

(51) Int. Cl. H01M 8/04746; G05D 16/20; H01M 8/04014; H01M 8/0438; H01M 8/04664

(52) U.S. Cl. CPC H01M 8/04761; G05D 16/2024; H01M 8/04014; H01M 8/04395; H01M 8/04679; H01M 8/04753; H01M 8/04768; H01M 2250/20

(57) ABSTRACT

In A fuel cell system and a method of controlling the same, the fuel cell system includes a coolant pump configured to circulate coolant along a coolant loop in which a fuel cell stack is disposed, an operating pressure regulating valve configured to adjust an operating pressure of the fuel cell stack and to control the flow of the exhaust gas emitted from the fuel cell stack, and an expander configured to selectively receive the flow of the exhaust gas by the adjusting of the operating pressure regulating valve and power the coolant pump.

### CROSS REFERENCE TO RELATED APPLICATION

The present application claims priority to Korean Patent Application No. 10-2024-0002646, filed on Jan. 8, 2024, the entire contents of which is incorporated herein for all purposes by this reference.

### BACKGROUND OF THE PRESENT DISCLOSURE

### Field of the Present Disclosure

The present disclosure relates to a fuel cell system and a method of controlling the same.

### Description of Related art

A hydrogen fuel cell can generate electrical energy through an electrochemical reaction between hydrogen and oxygen in the air. In recent years, research and development of fuel cell vehicles driven by the fuel cell have been actively conducted due to the eco-friendly aspect of a fuel cell.

The fuel cell generally includes a fuel cell stack to generate electrical energy, a hydrogen supply device to supply hydrogen as fuel to the fuel cell stack, an air supply device to supply oxygen in the air to the fuel cell stack, and a thermal management system to control the operating temperature of the fuel cell stack and electronic components.

The thermal management system of the fuel cell includes a coolant circuit. The fuel cell stack exchanges heat with a coolant circulating in the coolant circuit, and the temperature of the fuel cell may be controlled. For example, the coolant circulated by a coolant pump in the coolant circuit may dissipate the heat generated in the fuel cell stack from a radiator disposed in a heat exchange relationship with the coolant circuit.

There are several challenges to be solved in the thermal management system of a fuel cell.

First, a fail-safe mechanism is required. When the coolant pump fails in the fuel cell vehicle, damage to the fuel cell stack may occur due to the coolant overheating. To prevent this, the operating output of the vehicle becomes limited or operations of the fuel cell should even be stopped in a worst scenario. Therefore, the fuel cell requires a fail-safe mechanism to avoid limiting the operating output or stopping operations.

Furthermore, the size of a system and weight in a fuel cell should be considered, along with the high cooling performance. Fuel cells operate at a relatively low temperature, so their cooling performance is disadvantageous compared to internal combustion engines. For the present reason, a larger flow rate of coolant is required in a fuel cell. To secure the amount of cooling flow, the consumption output of the coolant pump needs to increase, or the size of the coolant pump needs to increase, which is disadvantageous in terms of the package.

Additionally, it is required to manage the hydrogen concentration emitted from the fuel cell. The fuel cell emits exhaust gas containing hydrogen. To meet regulations for the safety of vehicle drivers, it is necessary to manage the exhausted hydrogen concentration. For the management of the hydrogen concentration, it is required to tune the operation control of a fuel cell system and improve hardware. However, it is difficult to reduce the hydrogen concentration when high-concentration hydrogen with a high flow rate is rapidly emitted.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell system that can adjust the output of a coolant pump according to the required output of the coolant pump for a fuel cell in each situation.

The present disclosure may provide a fuel cell system that includes a fail-safe mechanism of the coolant pump.

Furthermore, the present disclosure may provide a fuel cell system that reduces the concentration of hydrogen emitted from the fuel cell.

Also, the present disclosure may provide a method to control a fuel cell to solve the above problems.

An objective of the present disclosure is not limited to the above-mentioned objectives, and other objectives not mentioned will be clearly understood by one having ordinary skill in the art in the field of the present disclosure to which the present disclosure pertains from the description below.

To achieve the objectives of the present disclosure as described above and to perform the characteristic functions of the present disclosure as described later, the features of the present disclosure are as follows.

The fuel cell system according to an embodiment of the present disclosure may include a coolant pump configured to circulate a coolant along a coolant loop in which a fuel cell stack is disposed, an operating pressure regulating valve configured to adjust an operating pressure of the fuel cell stack and to control the flow of exhaust gas emitted from the fuel cell stack, and an expander configured to be selectively supplied with the flow of the exhaust gas by the adjusting of the operating pressure regulating valve and to supply the coolant pump with power.

According to an embodiment of the present disclosure, a method of controlling a fuel cell may include determining a state of a fuel cell as to whether the fuel cell operates normally or abnormally based on the operating data of the fuel cell by a controller that is configured to control the operating of a fuel cell where coolant is circulated by a coolant pump and selectively directing the flow of exhaust gas emitted from the fuel cell to an expander configured to assist the output of the coolant pump based on the state of the fuel cell.

According to an embodiment of the present disclosure, provided is a fuel cell system that may adjust the output of the coolant pump according to the required output of the coolant pump for the fuel cell in each situation.

The present disclosure may provide the fuel cell system that includes a fail-safe mechanism for the coolant pump.

According to an embodiment of the present disclosure, the fuel cell system may reduce the concentration of hydrogen emitted from the fuel cell.

Furthermore, according to an embodiment of the present disclosure, provided is a method for controlling the fuel cell to solve the above problems.

The effects of the present disclosure may not be limited to those described above, and other effects not mentioned may be clearly recognized by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a fuel cell system according to an embodiment of the present disclosure.

FIG. 2 is a view showing a coolant pump that includes an expander of the fuel cell system according to an embodiment of the present disclosure.

FIG. 3 is a view showing an operating pressure regulating valve that operates in conjunction with the coolant pump of the fuel cell system according to an embodiment of the present disclosure.

FIG. 4 is a simplified cross-sectional view of the operating pressure regulating valve of FIG. 3.

FIG. 5, FIG. 6, FIG. 7, FIG. 8, FIG. 9, FIG. 10 and FIG. 11 are views showing an opening amount or position control of an operating pressure regulating valve according to various embodiments of the present disclosure.

FIG. 12, FIG. 13 and FIG. 14 are control flowcharts of the fuel cell system according to an embodiment of the present disclosure.

FIG. 15 is a block diagram of the fuel cell system according to another embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Specific structural or functional descriptions presented in embodiments of the present disclosure are illustrated only for explaining the embodiments according to the concept of the present disclosure, and the embodiments according to the concept of the present disclosure may be implemented in various forms. Furthermore, it should not be construed as being limited to the embodiments explained in the present specification, and should be understood as including all modifications, equivalents, or substitutes included in the spirit and technical scope of the present disclosure.

Meanwhile, in an embodiment of the present disclosure, terms such as a first and/or a second may be used to describe various components, but the above components are not limited to the above terms. These terms are intended only to distinguish one component from other components, for example, within the scope of the rights according to the concept of the present disclosure, a first component may be referred to as a second component, and similarly a second component may be referred to as a first component.

When it is stated that a component is “connected” or “linked” to another component, it should be understood that it may be directly connected or linked to that other component, but that another component may exist in the middle. On the other hand, when it is stated that one component is “directly connected” or “directly linked” to another component, it should be understood that no other component exists in the middle. Other expressions for explaining the relationship between components, such as “between” and “directly between” or “adjacent to” and “directly adjacent to” should be interpreted similarly.

Throughout the specification, the same reference numerals denote the same components. Meanwhile, the terms used herein are for describing embodiments and are not intended to limit the present disclosure. In the present specification, the singular form also includes the plural form unless specifically mentioned in the phrase. As used in the specification, “comprises” and/or “comprising” may mean that the mentioned components, steps, operations and/or elements do not exclude the presence or addition of one or more other components, steps, operations, and/or elements.

Hereinafter, the present disclosure will be described in detail with reference to the accompanying drawings.

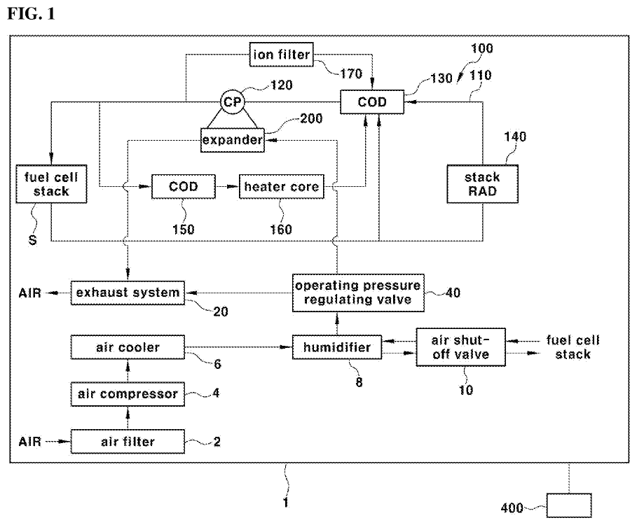

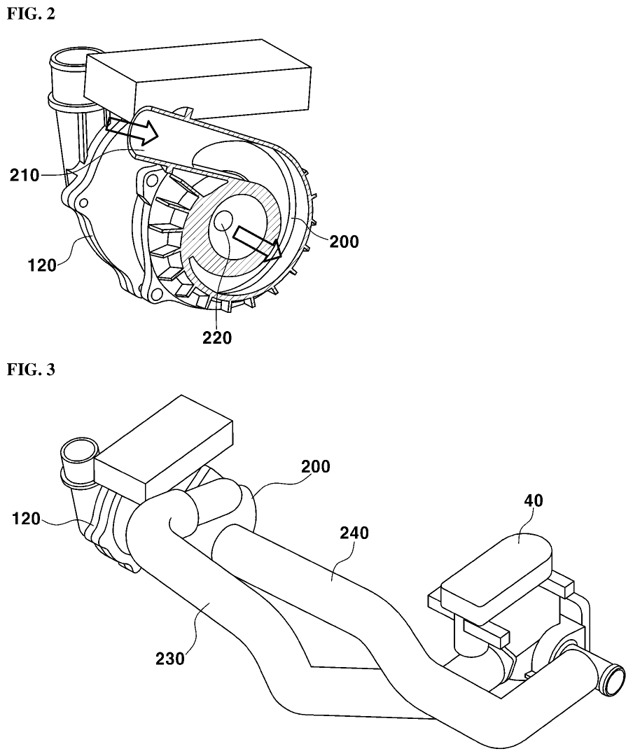

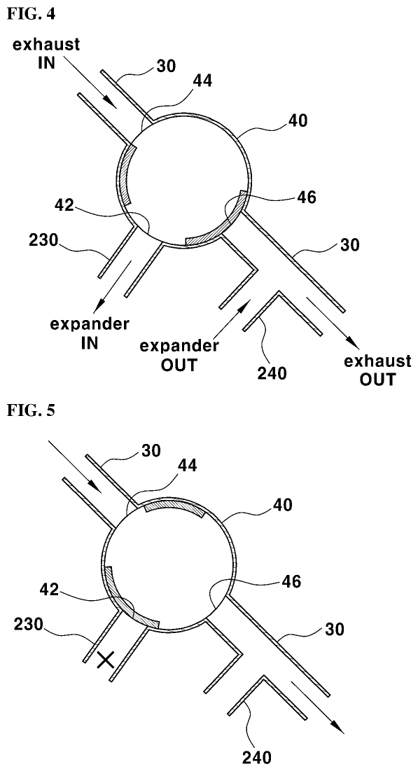

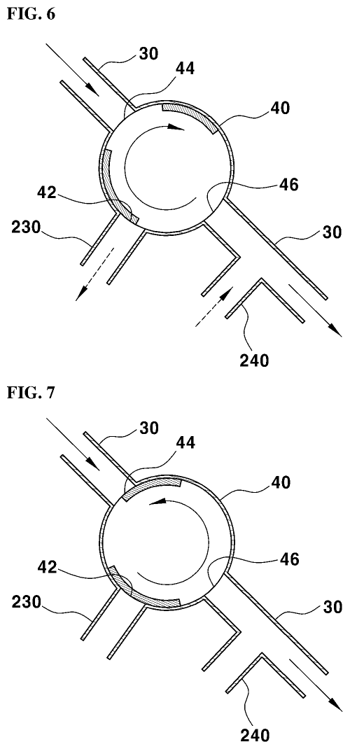

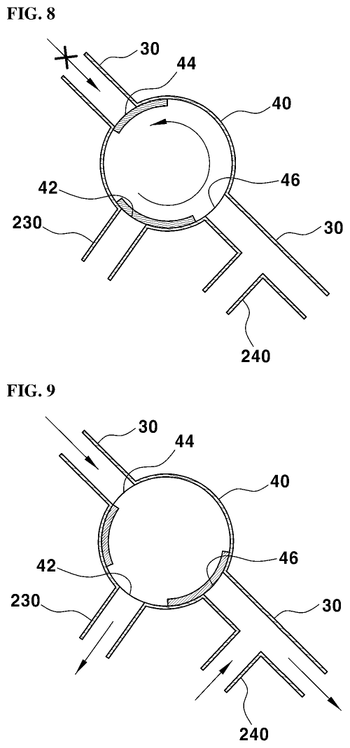

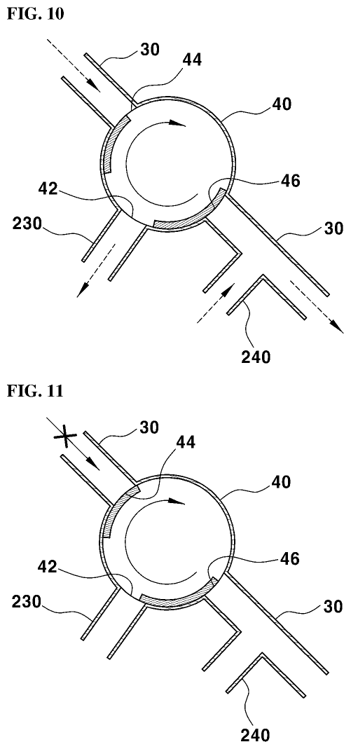

As shown in FIG. 1, a fuel cell system 1 may include a fuel cell stack S. In the fuel cell stack S, electrical energy may be generated through a reaction between hydrogen supplied by a hydrogen supply device and oxygen in the air supplied by an air supply device. Hydrogen may be supplied to a hydrogen electrode of the fuel cell stack S, and oxygen may be supplied to an air electrode of the fuel cell stack S.

The air supply device may supply air to the air electrode of the fuel cell stack S. The supplied air may be filtered in an air filter 2, and compressed air may be generated by an air compressor 4. Compressed air may be directed to a humidifier 8 through an air cooler 6. The dry air cooled by the air cooler 6 may be humidified in the humidifier 8 and supplied to the fuel cell stack S. An air shut-off valve 10 is disposed between the humidifier 8 and the fuel cell stack S. Air entering and leaving the fuel cell stack S may be blocked by the control of the air shut-off valve 10.

After completing a reaction in the fuel cell stack S, moist air may be discharged from the air electrode. The discharged moist air may exchange moisture with the dry air through the humidifier 8 and may be discharged through an exhaust system 20.

The moist air discharged through the humidifier 8 may be configured to pass through an operating pressure regulating valve 40. The operating pressure of the fuel cell stack S may be controlled by controlling the opening amount of the operating pressure regulating valve 40.

The fuel cell system 1 may include a thermal management system 100. The thermal management system 100 may include a coolant loop 110 configured for a coolant to circulate. The fuel cell stack S is disposed in heat exchange relationship with the coolant of the coolant loop 110.

The coolant may be configured to circulate by a coolant pump (CP) 120. The flow of the coolant in the coolant loop 110 may be controlled by a control valve (CV) 130. For example, the coolant that absorbs the reaction heat of the fuel cell stack S in the coolant loop 110 may be directed to a stack radiator (stack RAD) 140 by the control valve 130. In the stack radiator 140 the coolant may be cooled and circulated again to the fuel cell stack S. Also, the coolant in the coolant loop 110 may be heated up through a cathode oxygen depletion (COD) heater 150. The coolant heated by the COD heater 150 may be disposed in heat exchange relationship with a heater core 160. An ion filter 170 may be disposed in the coolant loop 110. The ion filter 10 may remove ions contained in the coolant that flows into the fuel cell stack S.

The exhaust gas generated after completing the reaction in the fuel cell stack S may be discharged through the exhaust system 20. According to an embodiment of the present disclosure, the thermal management system 100 may operate in conjunction with the exhaust system 20 of a fuel cell. Accordingly, the present disclosure may adjust the output of the coolant pump 120 according to the required output of the coolant pump 120 in each situation. When a high output of the coolant pump 120 is required, the output may be assisted using exhaust gas. In general operation, the fuel-efficient operation may be promoted by reducing the output of the coolant pump 120. Furthermore, the present disclosure may enable a fail-safe operation when the coolant pump 120 fails. Additionally, the present disclosure may reduce the exhausted hydrogen concentration through a cooperative operation of the thermal management system 100 and the exhaust system 20.

According to an embodiment of the present disclosure, the exhaust gas discharged from the fuel cell stack S may be directed to the coolant pump 120. The exhaust gas may be directed to the coolant pump 120 by the operating pressure regulating valve 40.

The coolant pump 120 may assist the output of the coolant pump 120 using the flow of exhaust gas. To the present end, according to an embodiment of the present disclosure, the thermal management system 100 may include an expander 200.

As shown in FIG. 2 and FIG. 3, the expander 200 may be formed as one body with the coolant pump 120 in one implementation. The expander 200 may obtain energy through the flow of the exhaust gas and then operate the coolant pump 120. The expander 200 may receive the flow of the exhaust gas from an expander line 230 connected to the operating pressure regulating valve 40. Also, the expander 200 may send the exhaust gas supplied to the expander 200 to the exhaust system 20 through a discharge line 240. The discharge line 240 may be connected to an exhaust line 30 of the exhaust system 20. In an embodiment of the present disclosure, the expander 200 may include an inlet 210 and an outlet 220. The inlet 210 may be connected to the expander line 230, and the outlet 220 may be connected to the discharge line 240.

Referring to FIG. 4, the operating pressure regulating valve 40 may include a first passage 42, a second passage 44, and a third passage 46. The opening/closing or the opening amount of the first passage 42, the second passage 44, and the third passage 46 may be adjusted.

The first passage 42 may be connected to the expander line 230. The flow of the exhaust gas through the exhaust line 30 may be supplied to the expander 200 through the first passage 42.

The operating pressure regulating valve 40 may be configured to be in fluid communication with the exhaust line 30 of the fuel cell stack S. The second passage 44 may be connected to the upstream of the exhaust line 30 or to the humidifier 8, and the third passage 46 may be connected to the downstream of the exhaust line 30.

The opening/closing or the opening amount of the passages 42, 44, 46 of the operating pressure regulating valve 40 may be adjusted. In an embodiment of the present disclosure, the fuel cell system 1 may include a controller 400. The controller 400 may be configured to control the operation of the fuel cell system 1. The controller 400 may be configured for controlling the operation of the operating pressure regulating valve 40. The controller 400 may be configured for controlling the opening/closing or the opening amount of each passage 42, 44, 46 of the operating pressure regulating valve 40.

Furthermore, the controller 400 may collect operating data of the fuel cell system 1. The controller 400 may collect hydrogen data of the fuel cell system 1. The hydrogen data may include the operating data, such as the pressure of hydrogen, the temperature of hydrogen, the purge amount, the recirculation amount and the like. The fuel cell stack S or the fuel cell system may include various sensors configured to obtain the hydrogen data, and the controller 400 may communicate with the fuel cell stack S to obtain the hydrogen data. The controller 400 may collect air data of the fuel cell. The air data may include operating data, such as air pressure, flow rate and temperature, exhaust hydrogen concentration, revolutions per minute (RPM) of the air compressor 4, and information on the opening amount of various valves. The fuel cell stack S or the fuel cell system may include various sensors configured to obtain the air data, and the controller 400 may obtain the air data from the fuel cell stack S or the fuel cell system. Furthermore, the controller 400 may collect operating data indicating the operation state of various components of the thermal management system 100. The operating data indicating the operation state of the various components of the thermal management system 100 may include the coolant pressure of the fuel cell stack S, the temperature, the opening amount of the control valve 130, revolutions per minute (RPM) of the coolant pump 110, and the like. The thermal management system 100 may include various sensors configured to obtain the operating data indicating the operation state of the various components of the thermal management system 100, and the controller 400 may obtain the operating data from the thermal management system 100.

According to an embodiment of the present disclosure, the above-described problem may be solved by controlling the operating pressure regulating valve 40 according to the operating situation of the fuel cell.

Referring to FIG. 5, FIG. 6, FIG. 7, FIG. 8, FIG. 9, FIG. 10 and FIG. 11, the operating pressure regulating valve 40 may be controlled.

In an embodiment of the present disclosure, the operating pressure regulating valve 40 may include an actuator operatively connected to the controller 40 so as to selectively rotate rotary valves in order to selectively open the first, second and third passages 42, 44 and 46.

Operations of the fuel cell system 1 may include normal pressure operation (or atmospheric operation) and pressurized operation. During the pressurized operation, air at a pressure higher than normal pressure (atmospheric pressure) may be supplied to the fuel cell stack S. Furthermore, during the pressurized operation, the outlet pressure of the air electrode of the fuel cell stack S may be controlled using the operating pressure regulating valve 130.

As shown in FIG. 5, during normal pressure operation of the fuel cell, the controller 400 may be configured for controlling the operating pressure regulating valve 130 to block the first passage 42 which is connected to the expander line 230. For example, when the output assistance of the coolant pump 120 is not required, the controller 400 may be configured for controlling the operating pressure regulating valve 130 to enable the flow of the exhaust gas only through the second passage 44 and the third passage 46.

Referring to FIG. 6, according to an embodiment of the present disclosure, the output of the coolant pump 120 may be assisted during normal pressure operation of the fuel cell. In an embodiment of the present disclosure, the controller 400 may open at least a portion of the first passage 42 in the state of FIG. 5 to direct a part of the flow of the exhaust gas to the expander 200. The expander 200 may be rotated by a part of the flow of the exhaust gas to operate the coolant pump 120. By operation of the expander 200, the output of the coolant pump 120 may be assisted, and the fuel efficiency operation may be promoted.

As shown in FIG. 7, during the pressurized operation of the fuel cell, the outlet pressure of the air electrode of the fuel cell stack S may be controlled by the operating pressure regulating valve 40. The controller 400 may be configured for controlling the operating pressure of the fuel cell by adjusting the opening amount of the second passage 44 in a state where the first passage 42 is closed and the third passage 46 is open. As in the illustrated implementation example, the controller 400 may be configured for controlling the outlet pressure of the air electrode by controlling the operating pressure regulating valve 40 to close the first passage 42 and to at least partially open the second passage 44.

As shown in FIG. 8, the operating pressure regulating valve 40 may perform a function of an air shut-off valve. If air needs to be blocked, the controller 400 may close the first passage 42 and the second passage 44 of the operating pressure regulating valve 40.

As shown in FIG. 9, the output of the coolant pump 120 may be assisted through the control of the operating pressure regulating valve 40. At the instant time, the controller 400 may fully open the first passage 42 and fully close the third passage 46. Then the controller 400 may open the second passage 44 so that the entire flow of exhaust gas flows to the expander line 230. In the instant case, the expander 200 may be operated by the flow of exhaust gas, and the coolant pump 120 may be operated by the expander 200. Thus, according to an embodiment of the present disclosure, a fail-safe mechanism may be provided since the coolant pump 120 circulates the coolant along the coolant loop 110 even when the coolant pump 120 is broken. Furthermore, the exhaust hydrogen concentration may be reduced since the flow of the exhaust gas directed to the expander 200 maximizes the mixing of hydrogen and air while passing through the expander 200.

As shown in FIG. 10, according to some exemplary embodiments of the present disclosure, the output of the coolant pump 120 may be assisted during pressurized operation. The controller 400 may close the third passage 46. At the same time, the controller 400 may fully open the first passage 42 and at least partially open the second passage 44 so that the output of the coolant pump 120 is assisted and the operating pressure of the fuel cell is simultaneously controlled.

When the output of the coolant pump 120 is assisted by the flow of exhaust gas, as shown in FIG. 11, blocking air may also be possible. The controller 400 may completely close the second passage 44. Furthermore, the first passage 42 and the third passage 46 may be partially open so that the output of the coolant pump 120 by exhaust gas is assisted, and the function of the air shut-off valve may be provided.

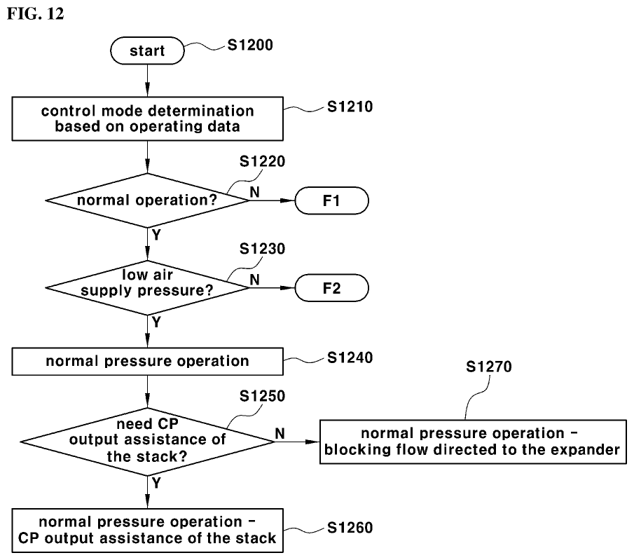

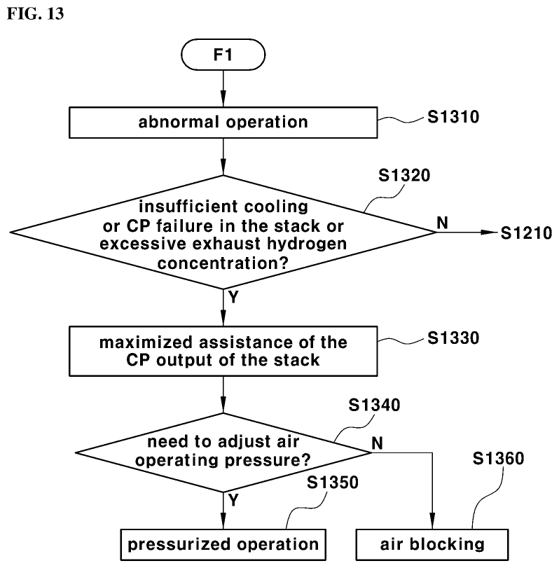

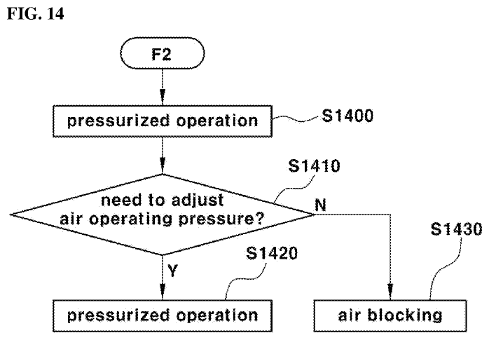

Hereinafter, the control of the fuel cell system 1 according to an embodiment of the present disclosure will be described with reference to FIG. 12, FIG. 13 and FIG. 14.

Referring to FIG. 12, the control of the fuel cell system 1 may start at operation S1200. The controller 400 may be configured to determine a control mode to perform based on the operating data of the fuel cell at operation S1210. The control mode may include a normal operation mode and an abnormal operation mode of the fuel cell. The normal operation mode may refer to a case in which the supply of hydrogen and air and the cooling of the fuel cell stack S are smoothly carried out based on the control logic preset in the fuel cell system to meet the output performance required by the driver of the fuel cell or the fuel cell vehicle. The abnormal operation mode may refer to a case in which this is not the case.

Whether the fuel cell is currently in a normal operation mode or an abnormal operation mode may be determined based on the operating data of the fuel cell collected by the controller 400. The controller 400 may be configured to determine that the fuel cell is in a normal operation mode when the hydrogen data, air data, and cooling data of the fuel cell included in the operating data are all within a preset range. Regarding the hydrogen data, for example, the controller 400 may be configured to determine that the fuel cell is in a normal operation mode when the supply and circulation of hydrogen to the fuel cell is within a preset range based on the pressure, flow rate, and recirculation flow rate of hydrogen which is supplied to the fuel cell stack S. Regarding the air data, the controller 400 may be configured to determine that the fuel cell is in a normal operation mode when the pressure, flow rate, and humidity of the air and the exhaust hydrogen concentration that are supplied to the fuel cell stack S are within a preset range. Regarding the cooling data, for example, the controller 400 may be configured to conclude that the fuel cell is in a normal operation mode when the operating temperature, cooling flow rate, and pressure of the fuel cell stack S are within a preset range.

Conversely, when at least some of the hydrogen data, air data, and cooling data in the operating data of the fuel cell are outside a preset range, the controller 400 may be configured to determine that the fuel cell is in an abnormal operation mode. For example, when there is a lack of hydrogen and air pressure or flow rate of the fuel cell, or a lack of cooling, the controller 400 may be configured to conclude that the fuel cell is in an abnormal operation mode.

The controller 400 may be configured to determine whether the fuel cell is in normal operation at operation S1220. The normal operation may mean a state in which the supply of air and hydrogen, and cooling are smoothly carried out in a normal control logic state, and the fuel cell stack S may be operated according to the needs of the vehicle.

When the fuel cell is determined to normally operate, the controller 400 may be configured to determine whether the air supply pressure supplied to the fuel cell stack S is low at operation S1230. For example, the controller 400 may be configured to determine whether the air supply pressure is low by comparing the current air supply pressure with a reference value. The air supply pressure may be measured by an air pressure sensor provided in the fuel cell stack S or the fuel cell system 1, and the controller 400 may collect information measured by the air supply pressure sensor.

When the air supply pressure is determined to be less than or equal to the reference value, the controller 400 may be configured to determine that the fuel cell is operating in normal pressure (or atmospheric pressure) at operation S1240. During normal pressure operation, the fuel cell system is operated at a relatively low pressure, and the efficiency and fuel efficiency of the system may be primarily considered.

According to one implementation, at operation S1250, the controller 400 may be configured to determine whether the output assistance of the coolant pump 120 of the fuel cell stack S is required. When the output assistance of the coolant pump 120 is determined to be necessary, the controller 400 may assist the output of the coolant pump 120 by partially opening the first passage 42 to direct the flow of the exhaust gas to the expander line 230 at operation S1260 (see FIG. 6). Conversely, when the output assistance is not required, the controller 400 may close the first passage 42 and direct the flow of the exhaust gas to the third passage 46 through the second passage 44 at operation S1270 (see FIG. 5). In some implementations, whether the output assistance of the coolant pump 120 is required may be determined based on the temperature of the coolant circulating in the coolant loop 110. For instance, when the temperature of the coolant is greater than a preset temperature, it may be determined that the coolant pump 120 requires the output assistance. In some implementations, whether the output assistance of the coolant pump 120 is required may be determined to be necessary when the fuel cell is in the normal operation mode to reduce the concentration of exhaust hydrogen.

Referring to FIG. 13, when the fuel cell is determined at operation S1220 not to normally operate, the controller 400 may execute operations under F1. When the operation is not normal, the controller 400 may be configured to determine that the fuel cell abnormally operates at operation S1310.

At operation S1320, the controller 400 may be configured to determine whether the operation is abnormal. The abnormal operation may mean that the cooling of the fuel cell is insufficient, the coolant pump 120 of the fuel cell stack S is failed, or the hydrogen concentration of exhaust gas exceeds a reference hydrogen concentration. The cooling of the fuel cell may be determined to be insufficient when the temperature of the coolant is greater than a preset temperature. When all of these conditions are not satisfied, the process may return to operation S1210. On the other hand, when one of these conditions is determined to be satisfied, the controller 400 may be configured to maximally assist the output of the coolant pump 120 at operation S1330 (a state of FIG. 9). In other words, the first passage 42 may be completely opened and the third passage 46 may be closed so that the entire flow of exhaust gas may be directed to the expander 200. Through the present control, the output of the coolant pump 120 may be boosted to a maximum output when cooling is insufficient or the fail-safe function may be performed when the coolant pump 120 is failed. Moreover, the hydrogen concentration may be reduced when the exhaust hydrogen concentration is excessive.

At operation S1340, the controller 400 may be configured for controlling the air operating pressure when necessary. When it is necessary to adjust the outlet pressure of the air electrode, the controller 400 may adjust the opening amount of the second passage 44 such as partially closing the second passage 44 at operation S1350 (a state of FIG. 10). Operating a fuel cell system at atmospheric pressure is generally fuel-efficient under a normal operating condition, yet pressurization may be necessary under an operating condition where an increase in output of the system is required (e.g., in a high temperature condition). The fuel cell system may be placed under the pressurized operation through adjusting the outlet pressure, which is determined based on the required output of the fuel cell system. At operation S1360, when adjustment of the air operating pressure is not necessary and air blocking is necessary, the controller 400 may perform control to close the second passage 44 and partially open the third passage 46 (a state of FIG. 11). Air blocking may be necessary for durability while the fuel cell system is not operating, e.g., vehicle turned off. If air is not blocked using the valve 40, the fuel cell stack S may be degraded due to the air flowing into the fuel cell stack S even while the vehicle is turned off.

When it is determined at operation S1230 that the air supply pressure exceeds the reference value, the controller 400 may perform operations under F2. Referring to FIG. 14, when the air supply pressure exceeds the reference value, the controller 400 may be configured to conclude that the fuel cell is in the pressurized operation at operation S1400.

In some implementations, the controller 400 may be configured to determine whether adjustment of the air operating pressure is necessary during pressurized operation at operation S1410. When it is necessary to adjust the outlet pressure at operation S1420, the controller 400 may adjust the pressure by partially opening the second passage 44 (see FIG. 7). Furthermore, the controller 400 may perform the function of an air shut-off valve by closing the second passage 42 at operation S1430 (see FIG. 8).

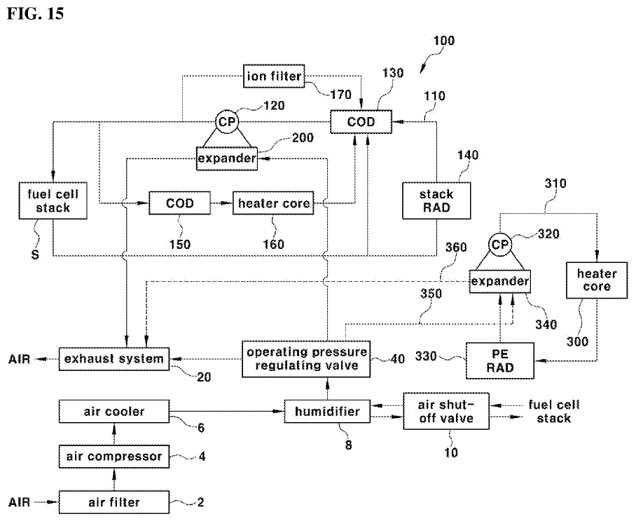

As depicted in FIG. 15, according to some embodiments of the present disclosure, the thermal management system 100 may include a second coolant loop 310 for the temperature regulation of one or more electronic components 300 such as a heater core. The second coolant loop 310 may include a second coolant pump 320, and the coolant may be circulated along the second coolant loop 310 by the second coolant pump 30. The coolant may exchange heat with an electronic component radiator 330 (PE RAD) disposed in the second coolant loop 310.

According to an embodiment of the present disclosure, the second coolant loop 310 may be operated in conjunction with the exhaust system 20. In an exemplary embodiment of the present disclosure, the second coolant loop 310 may be operated together with the exhaust system 20, together with the coolant loop 110. In an exemplary embodiment of the present disclosure, the second coolant pump 320 may include an expander 340.

The expander 340 may be supplied with the flow of the exhaust gas discharged from the fuel cell stack S. the flow of the exhaust gas may be allowed or blocked by the operating pressure regulating valve 40. The operating pressure regulating valve 40 may be coupled to the expander 340 of the second coolant loop 310 by an electronic component line 350 in a way to enable fluid communication. Furthermore, the expander 340 of the second coolant loop 310 may be connected to the exhaust system 20 or the exhaust line 30 by a return line 360.

According to an embodiment of the present disclosure, the fuel cell system may adjust the output of a coolant pump according to the required output of the coolant pump for a fuel cell in each situation.

The present disclosure may provide the fuel cell system that includes a fail-safe mechanism of a coolant pump.

According to an embodiment of the present disclosure, the fuel cell system may reduce the hydrogen concentration emitted from the fuel cell.

Furthermore, according to an embodiment of the present disclosure, a fuel cell control method may solve the above problems.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell system, the system comprising:
a coolant pump configured to circulate a coolant along a coolant loop in which a fuel cell stack is disposed;
an operating pressure regulating valve configured to adjust an operating pressure of the fuel cell stack and to control a flow of exhaust gas discharged from the fuel cell stack; and
an expander configured to selectively be supplied with the flow of exhaust gas by adjusting the operating pressure regulating valve and to supply the coolant pump with power.

2. The system of claim 1, further comprising a controller operatively connected to the operating pressure regulating valve and configured to control a position of the operating pressure regulating valve based on an operation state of the fuel cell system.

3. The system of claim 1,
wherein the operating pressure regulating valve includes a first passage, a second passage, and a third passage whose opening amount is adjustable,
wherein the first passage is configured to fluidically communicate with the expander,
wherein the second passage is configured to be supplied with the flow of the exhaust gas discharged from the fuel cell stack therethrough, and
wherein the third passage is configured to discharge the flow of the exhaust gas therethrough.

4. The system of claim 3, wherein the operating pressure regulating valve is disposed upstream of an exhaust system of the fuel cell stack, and an exhaust line for receiving the flow of the exhaust gas from the expander is provided downstream of the operating pressure regulating valve.

5. The system of claim 1, wherein the expander is integrally formed with the coolant pump.

6. The system of claim 1, further comprising:
an expander line connecting the operating pressure regulating valve disposed in an exhaust line and the expander to each other, wherein the flow of the exhaust gas is directed to the expander; and
a discharge line directing an exhaust gas from the expander to the exhaust line.

7. The system of claim 2, wherein the controller is further configured to:
determine an operation state of the fuel cell stack as to whether the fuel cell stack normally or abnormally operates based on an operating data of the fuel cell stack; and
selectively direct the flow of the exhaust gas discharged from the fuel cell stack to the expander configured to assist an output of the coolant pump based on the operation state of the fuel cell stack.

8. The system of claim 7, wherein whether the operation state of the fuel cell stack is in abnormal is determined based on at least one of a cooling state of the fuel cell stack, whether the coolant pump is in normal operation, and a hydrogen concentration of the flow of the exhaust gas.

9. A vehicle, comprising the system of claim 1.

10. A method of controlling a fuel cell, the method comprising:
by a controller configured to control operation of the fuel cell, wherein a coolant is configured to circulate by a coolant pump in the fuel cell,
determining, by the controller, an operation state of the fuel cell as to whether the fuel cell normally or abnormally operates based on an operating data of the fuel cell; and
selectively directing, by the controller, a flow of exhaust gas discharged from the fuel cell to an expander configured to assist an output of the coolant pump based on the operation state of the fuel cell.

11. The method of claim 10, further comprising:
controlling an operating pressure regulating valve by the controller,
wherein the operating pressure regulating valve includes:
a first passage to be in fluid communication with the expander;
a second passage, wherein the flow of the exhaust gas flows into the operating pressure regulating valve therethrough; and
a third passage, wherein the flow of the exhaust gas is discharged therethrough,
wherein opening amounts of the first passage, second passage, and third passage are adjustable.

12. The method of claim 11, further comprising:
fully opening, by the controller, the first passage of the operating pressure regulating valve to direct all of the flow of the exhaust gas that flows into the operating pressure regulating valve to the expander, in response to determining that the operation state of the fuel cell is abnormal.

13. The method of claim 12, wherein whether the operation state of the fuel cell is in abnormal is determined based on at least one of a cooling state of the fuel cell, whether the coolant pump is in normal operation, and a hydrogen concentration of the flow of the exhaust gas.

14. The method of claim 12, further comprising:
adjusting, by the controller, the opening amount of the second passage based on determining whether adjusting an operating pressure of the fuel cell is necessary.

15. The method of claim 12, further comprising:
in response to determining that blocking an air supply to the fuel cell is required, by the controller,
closing the second passage;
at least partially closing the first passage; and
at least partially opening the third passage.

16. The method of claim 11, further comprising:
determining, by the controller, whether a supply pressure of air supplied to the fuel cell is less than or equal to a predetermined reference pressure in response that the operation state of the fuel cell is normal; and
determining, by the controller, whether the fuel cell is in atmospheric pressure operation or pressurized operation based on the supply pressure of the air.

17. The method of claim 16, further comprising:
closing, by the controller, the first passage completely, opening the third passage completely, and adjusting the opening amount of the second passage upon concluding that adjustment of an operating pressure of the fuel cell is required, during pressurized operation where the supply pressure of the air exceeds the predetermined reference pressure.

18. The method of claim 16, further comprising closing, by the controller, the second passage in response to determining that shut off of an air supply to the fuel cell is required.

19. The method of claim 16, further comprising:
opening, by the controller, the second passage and the third passage and at least partially opening the first passage in response to determining that an output assistance of the coolant pump is required, during normal pressure operation where the supply pressure of the air is less than or equal to the predetermined reference pressure.
